(19) United States
(12) Patent Application Publication
(10) Pub. No.: US 2021/0304439 A1
(43) Pub. Date: Sep. 30, 2021

(54) SENSING METHOD AND APPARATUS

(71) Applicant: LG INNOTEK CO., LTD., Seoul (KR)

(72) Inventors: Jung Ah PARK, Seoul (KR); Jong Hyun MA, Seoul (KR); Seung Won LEE, Seoul (KR)

(73) Assignee: LG INNOTEK CO., LTD., Seoul (KR)

(21) Appl. No.: 17/265,271

(22) PCT Filed: Aug. 13, 2019
(86) PCT No.: PCT/KR2019/010256

§ 371 Date: Feb. 2, 2021

(30) Foreign Application Priority Data
Aug. 16, 2018 (KR) 10-2018-0095577

(51) Int. Cl. G06T 7/80; G06K 9/34; G06T 7/521; G06K 9/46

(52) U.S. Cl. CPC G06T 7/80; G06K 9/34; G06K 9/4661; G06K 9/4604; G06K 9/4652; G06T 7/521

(57) ABSTRACT

Disclosed are a sensing method and apparatus, according to one embodiment, which process distance information about a feature point by capturing a pattern image. Specifically, disclosed are a sensing method and apparatus capable of improving the quantity and/or accuracy of information to be sensed, by appropriately realizing repeating shapes of a pattern image.

### TECHNICAL FIELD

In the present disclosure, a method and apparatus for sensing according to one or more embodiments are disclosed.

### BACKGROUND ART

Apparatuses that acquire information by outputting a light and reflecting it on an object have been used in various fields. For example, from 3D cameras to distance measurement techniques, technologies for obtaining information by outputting a light are used in several ways.

For an example, Time of Flight (TOF) is a term representing the principle of measuring the distance by measuring the time difference between the time when a light is outputted and the time of reception of the light reflected and returned from an object, and since TOF technology is simple to be implemented, it is used in various fields such as aviation, shipbuilding, civil engineering, cameras, surveying, and the like.

In this regard, there is a need for a specific method of performing correction or calibration in the manufacturing process of a sensing apparatus.

### DETAILED DESCRIPTION OF THE INVENTION

### Technical Subject

The present disclosure may provide a method and an apparatus for sensing light according to one or more embodiments. Specifically, a method and apparatus for performing correction or calibration in a sensing apparatus are disclosed. In addition, a pattern for performing correction or calibration may be initiated.

The technical problem to be solved is not limited to the technical problems as described above, and various technical problems may be further included within the scope that is obvious to a person skilled in the art.

### Technical Solution

A sensing apparatus according to the first aspect comprises: a receiver for receiving distance information on a feature point indicated by a repetitive shape included in a pattern image; a sensor for acquiring a plurality of pattern images through capturing multiple times of the pattern image from different angles, determining the feature point from the plurality of pattern images, and sensing distance information on the feature point; and a processor that compares the received distance information with the sensed distance information and determines a correction value being used when sensing the distance information, wherein the pattern image includes a second color region and a first color region, a reflectance of the first color region is greater than that of the second color region, and the entire area of an overlapping image in which the plurality of pattern images are overlapped may be determined at least once as a first color region.

In addition, the pattern image may include a pattern in which two fan shapes whose origins are in contact with each other are repeated.

In addition, the pattern image may include a pattern in which dots are repeatedly disposed at preset intervals.

In addition, the pattern image may include a pattern in which a first single closed curve including a plurality of angles and a second single closed curve that is in the shape of a curve and is contained within the first single closed curve are repeated.

In addition, a region between the first single closed curve and the second single closed curve is colored, and a region inside the second single closed curve may be colorless.

A sensing apparatus according to the second aspect comprises: a receiver for receiving distance information on a feature point indicated by a repetitive shape included in a pattern image; a sensor for acquiring a plurality of pattern images through capturing multiple times of the pattern image from different angles, determining the feature point from the plurality of pattern images, and sensing distance information on the feature point; and a processor that compares the received distance information with the sensed distance information and determines a correction value being used when sensing the distance information, wherein the pattern image may include a pattern in which two fan shapes whose origins are in contact with each other are repeated.

A sensing apparatus according to the third aspect comprises: a receiver for receiving distance information on a feature point indicated by a repetitive shape included in a pattern image; a sensor for acquiring a plurality of pattern images through capturing multiple times of the pattern image from different angles, determining the feature point from the plurality of pattern images, and sensing distance information on the feature point; and a processor that compares the received distance information with the sensed distance information and determines a correction value being used when sensing the distance information, wherein the pattern image may include a pattern in which dots are repeatedly disposed at preset intervals.

A sensing apparatus according to the fourth aspect comprises: a receiver for receiving distance information on a feature point indicated by a repetitive shape included in a pattern image; a sensor for acquiring a plurality of pattern images through capturing multiple times of the pattern image from different angles, determining the feature point from the plurality of pattern images, and sensing distance information on the feature point; and a processor that compares the received distance information with the sensed distance information and determines a correction value being used when sensing the distance information, wherein the pattern image may include a pattern in which a first single closed curve including a plurality of angles and a second single closed curve that is in the shape of a curve and is contained within the first single closed curve are repeated.

In addition, a region between the first single closed curve and the second single closed curve is colored, and a region inside the second single closed curve may be colorless.

A sensing method according to the fifth aspect comprises the steps of: receiving distance information on a feature point indicated by a repetitive shape included in a pattern image; acquiring a plurality of pattern images through capturing the pattern image multiple times from different angles; determining the feature point from the plurality of pattern images, and sensing distance information on the feature point; and comparing the received distance information with the sensed distance information, and determining a correction value being used when sensing the distance information, wherein the pattern image includes a second color region and a first color region, a reflectance of the first color region is greater than that of the second color region, and the entire area of an overlapping image in which the plurality of pattern images are overlapped may be determined at least once as a first color region.

The sixth aspect may provide a computer-readable recording medium in which a program for executing the method according to the fifth aspect on a computer is recorded.

A calibration apparatus according to the seventh aspect comprises: a memory for storing distance information on a feature point indicated by a repetitive shape included in a pattern image; and a processor that receives sensed distance information for feature points included in a plurality of pattern images acquired by capturing the pattern image from different angles, and determines a correction value by comparing the stored distance information with the sensed distance information, wherein the pattern image includes a first color region and a second color region, a reflectance of the first color region is greater than that of the second color region, and the entire area of the overlapping image in which the plurality of pattern images are overlapped may be determined at least once as a first color region.

In addition, a motor for rotating the camera module for capturing the pattern image may be further included.

### Advantageous Effects

The present disclosure may provide a method and an apparatus for sensing light according to one or more embodiments.

### BRIEF DESCRIPTION OF DRAWINGS

FIG. 1 is a conceptual diagram illustrating an example in which a sensing apparatus senses a pattern image and operates according to an embodiment.

FIG. 2 is a block diagram illustrating an example in which a sensing apparatus senses an inclined pattern image and operates according to an embodiment.

FIG. 3 is a diagram illustrating an example of a pattern image including a dot shape according to an embodiment.

FIG. 4 is a diagram illustrating an example of a pattern image including a fan shape according to an embodiment.

FIG. 5 is a diagram illustrating an example of a pattern image including a plurality of closed curve shapes according to an embodiment.

FIG. 6 is a diagram illustrating an example of acquiring a plurality of pattern images through capturing multiple times of a pattern image according to an embodiment.

FIG. 7 is a flowchart illustrating an example in which a sensing apparatus performs calibration according to an embodiment.

FIG. 8 illustrates an example in which a sensing apparatus according to an embodiment measures an error generated when assembling a sensor and a lens, and extracts a calibration value for correction.

FIG. 9 illustrates an example in which a sensing apparatus according to an embodiment corrects a distance error for each pixel.

FIG. 10 illustrates an example in which a sensing apparatus according to an embodiment corrects a distance error for each distance.

FIG. 11 is a block diagram illustrating an example in which a calibration apparatus operates in conjunction with a camera module according to an embodiment.

### BEST MODE

As for terms used in the embodiments, general terms that are currently widely used as possible are selected while considering functions in the present invention, but this may vary according to the intention of a person skilled in the art, precedent, the emergence of new technologies, and the like. In addition, in a specific case, there are terms arbitrarily selected by the applicant, and in this case, the meaning of the terms will be described in detail in the description part of the corresponding invention. Therefore, the terms used in the present invention should be defined based on the meaning of the term and the overall contents of the present invention, not a simple name of the term.

When a part of the specification is said to “comprise” a certain element, it means that other elements may be further included rather than excluding other elements unless otherwise stated. In addition, the terms “ . . . unit”, “ . . . module”, and the like refers to a unit that processes at least one function or operation, which may be implemented as hardware or software, or a combination of hardware and software.

Hereinafter, embodiments of the present invention will be described in detail with reference to the accompanying drawings so that a person skill in the art may easily implement the present invention. However, the present invention may be implemented in various different forms and is not limited to the embodiments described herein.

Hereinafter, embodiments of the present invention will be described in detail with reference to the drawings.

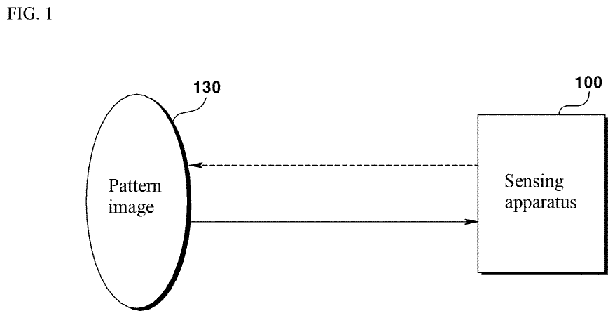

FIG. 1 is a conceptual diagram illustrating an example in which a sensing apparatus 100 senses a pattern image 130 and operates according to an embodiment.

A sensing apparatus 100 according to an embodiment may obtain image information and/or distance information on an object (e.g., pattern image 130).

The sensing apparatus 100 according to an embodiment may acquire image information on the pattern image 130 as well as distance information on each point of the pattern image 130. For example, the sensing apparatus 100 may acquire distance information for the pattern image 130 by using a time of flight (TOF) method.

The sensing apparatus 100 according to an embodiment may determine a feature point included in the pattern image 130 through image information obtained from the pattern image 130 and sense a distance to the feature point in a TOF method.

In addition, the sensing apparatus 100 may receive information on the pattern image 130 through a separate route. For example, distance information on a feature point of the pattern image 130 may be received through communication.

The sensing apparatus 100 according to an embodiment may determine whether the distance information acquired by the sensing apparatus 100 is accurate by comparing the sensed distance information with the received distance information. Or, the sensing apparatus 100 may compare the sensed distance information with the received distance information and determine a correction value if correction is required.

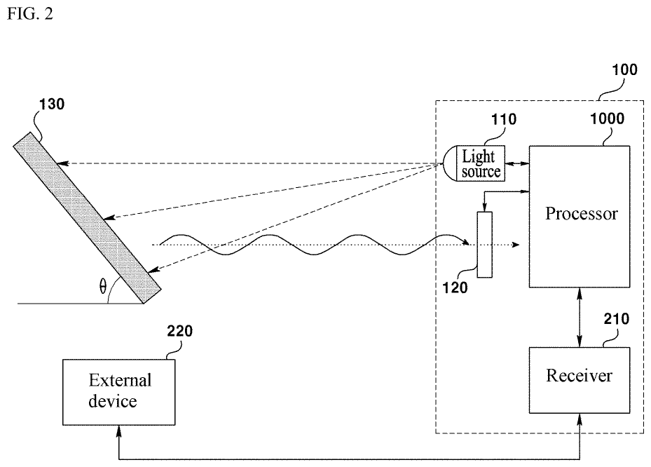

FIG. 2 is a block diagram illustrating an example in which a sensing apparatus 100 senses an inclined pattern image 130 and operates according to an embodiment.

As illustrated in FIG. 2, the sensing apparatus 100 may include a light source 110, a processor 1000, a sensor 120, and a receiver 210. Here, the light source 110 and the sensor 120 may be components of a camera module 1150.

However, it can be understood by a person skilled in the art that other general-purpose components other than the components illustrated in FIG. 2 may be further included in the sensing apparatus 100. For example, the sensing apparatus 100 may further include a filter (not shown). Or, according to another embodiment, it may be understood by a person skilled in the art that some of the components illustrated in FIG. 2 may be omitted. For example, the light source 110 may be omitted from the sensing apparatus 100.

Referring to FIG. 2, an example in which the sensing apparatus 100 determines a correction value through sensing a pattern image 130 when the pattern image 130 is inclined at an angle of θ is illustrated.

The pattern image 130 according to an embodiment may include a repetitive shape. For example, the pattern image 130 may include a pattern in which two fan shapes whose origins are in contact with each other are repeated. As another example, the pattern image 130 may include a pattern in which dots are repeatedly disposed at preset intervals. As another example, the pattern image 130 may include a pattern in which a first single closed curve including a plurality of angles and a second single closed curve that is in the shape of a curve and is contained within the first single closed curve are repeated.

The sensor 120 according to an embodiment may acquire a plurality of pattern images through multiple capturing of the pattern image at different angles. For example, the sensing apparatus 100 may acquire four different pattern images by capturing the pattern image 130 while rotating in a clockwise direction by 90 degrees with respect to an axis directed by the sensor 120. Since the pattern image 130 is inclined at an angle of θ, a distance sensed by the same pixel in the sensor 120 may be determined differently in four different pattern images.

The sensor 120 according to an embodiment may determine a feature point from a plurality of pattern images and sense distance information on the feature point.

The processor 1000 according to an embodiment may determine a feature point with a preset algorithm according to a pattern image. For example, when the pattern image 130 includes dots repeatedly disposed at preset intervals, the processor 1000 may determine a center point of each dot as a feature point. As another example, when the pattern image 130 includes a pattern in which two fan shapes whose origins are in contact with each other are repeated, the processor 1000 may determine the origin where the two fan shapes are in contact with each other as a feature point. As another example, when the pattern image 130 includes a pattern in which a first single closed curve including a plurality of angles and a second single closed curve that is in the shape of a curve and is contained within the first single closed curve are repeated, the processor 1000 may determine the point where a plurality of first single closed curves are in contact with each other as a feature point.

The processor 1000 according to an embodiment may determine a correction value being used when sensing the distance information by comparing the received distance information with the sensed distance information.

The processor 1000 may receive distance information on one or more feature points. In addition, the processor 1000 may sense distance information on one or more feature points. The processor 1000 may determine a correction value by comparing the received distance information with the sensed distance information. The received distance information may be actual measured distance information from the sensing apparatus 100 to a feature point. Accordingly, the processor 1000 may determine a difference between the received distance value and the sensed distance value as the error value. In addition, the processor 1000 may determine a correction value for correcting the determined error value based on the error value. For example, the correction value can be determined so that the error value becomes zero. The correction value refers to an arbitrary value being used for correction of a distance determination apparatus according to the TOF method, such as a value for adjusting a lens position, a value for adjusting a sensor position, and the like and is not limited.

The receiver 210 according to an embodiment may receive information from an external device 220. The receiver 210 may receive various pieces of information from the external device 220 through a preset communication method. For example, the receiver 210 may receive distance information on a feature point indicated by a repetitive shape included in a pattern image from the external device 220. The distance information on the feature point may include actual measurement information. In this case, the received distance information may indicate an ideal distance value from the sensing apparatus 100 to a feature point.

The pattern image 130 according to an embodiment includes a second color region and a first color region, and the entire area of an overlapping image in which a plurality of pattern images are overlapped may be determined at least once as a first color region.

In addition, multiple capturing may be performed as the sensing apparatus 100 rotates while the pattern image 130 is fixed.

For example, a case where the pattern image 130 is divided into a first area and a second area will be described. The first area may be located: on the left side in the first pattern image acquired by the first photographing, on the upper side in the second pattern image acquired by the second photographing, on the right side in the third pattern image acquired by the third photographing, and on the lower side of the fourth pattern image acquired by the fourth photographing. The second area may be located: on the right side in the first pattern image acquired by the first photographing, on the lower side in the second pattern image acquired by the second photographing, on the left side in the third pattern image acquired by the third photographing, and on the upper side of the fourth pattern image acquired by the fourth photographing. In this case, both the first area in the first pattern image and the second area in the third pattern image are located on the left side, both the first area in the second pattern image and the second area in the fourth pattern image are located on upper sides, both the first area in the third pattern image and the second area in the first pattern image are located on the right side, and both the first area in the fourth pattern image and the second area in the second pattern image may be located on the lower side. However, the entire area of the overlapped image in which all the first to fourth pattern images are overlapped may be determined at least once as the first color region. For example, all of the left, upper, right, and lower sides may be determined as the first color region at least once in the first to fourth pattern images. The reflectivity of the first color region may be greater than that of the second color region. For example, the first color region may be white, and the second color region may be black. Or, the reflectance of the first color region may be greater than or equal to a first value, and the reflectance of the second color region may be equal to or less than a second value.

The pattern image 130 includes a first color region and a second color region, the reflectance of the first color region is greater than that of the second color region, and the entire area of an overlapping image in which a plurality of pattern images are overlapped may be determined at least once as a first color region.

In addition, the pattern image 130 may be composed of a plurality of cells, and a ratio of the first color region and the second color region in each cell may be greater than or equal to a preset value. For example, in each cell, the first color region may be at least twice the second color region.

A display (not shown) according to an embodiment may display an image acquired through control of the processor 1000, and a display (not shown) according to an embodiment may be a liquid crystal display, a thin film transistor liquid crystal display, an organic light-emitting diode, a flexible display, a 3D display, an electrophoretic display, and the like.

The receiver 210 may communicate with the external device 220 in a preset manner, and both wired and wireless methods may be used. For example, the receiver 210 may communicate with the external device 220 using a Wi-Fi chip, a Bluetooth chip, or the like. The Wi-Fi chip and the Bluetooth chip can perform communication using a Wi-Fi method and a Bluetooth method, respectively. In the case of using a Wi-Fi chip or a Bluetooth chip, various types of connection information such as an SSID and a session key may be transmitted and received first, and then various types of information may be transmitted and received after a communication connection using the same. The wireless communication chip may perform communication according to various communication standards such as IEEE, ZigBee, 3rd Generation (3G), 3rd Generation Partnership Project (3GPP), and Long Term Evolution (LTE). The NFC chip can perform communications in a Near Field Communication (NFC) method using a 13.56 MHz band among various RF-ID frequency bands such as 135 kHz, 13.56 MHz, 433 MHz, 860 to 960 MHz, and 2.45 GHz.

The sensing apparatus 100 may determine a distance to a feature point for each of the acquired pattern images through sensing. For example, a case in which the sensing apparatus 100 acquires a first pattern image to a fourth pattern image by capturing the image of the inclined pattern image 130 while being rotated at 90 degree intervals will be described.

The sensing apparatus 100 senses and determines the distances to feature points included in the first pattern image, and compares the distances to the determined feature points with the ideal distance received from the external device 220 to determine a correction value. In addition, such an operation may be performed on all of the second pattern image, the third pattern image, and the fourth pattern image. Since light is almost absorbed in the second area, the more the second area is, the less information the sensing apparatus 100 can acquire. However, when the first pattern image to the fourth pattern image are overlapped, since the entire area is the first area at least once, there may be no area in which information acquisition is blocked.

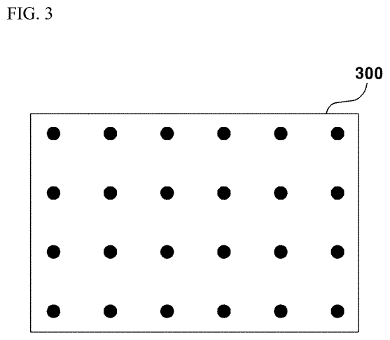

FIG. 3 is a diagram illustrating an example of a pattern image 300 including a dot shape according to an embodiment.

The pattern image 300 may include a pattern in which dots are repeatedly disposed at preset intervals. The pattern image 300 includes a plurality of dots, and the sensing apparatus 100 may determine a center point of each dot as a feature point. In addition, the sensing apparatus 100 may determine a correction value by comparing the distance to the sensed feature point and the distance to the received feature point.

The sensing apparatus 100 may determine a feature point according to a preset algorithm. For example, the sensing apparatus 100 may determine a center point of a dot shape sensed in the acquired pattern image 300 as a feature point. Since the second color region has a weaker intensity of reflected light than the first color region, the sensing apparatus 100 determines a dot shape based on the difference between the reflectance of the second color region and the first color region, and determines the center point of the dot shape, thereby determining the feature point.

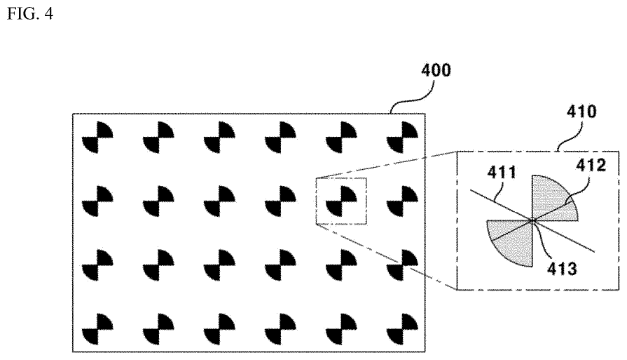

FIG. 4 is a diagram illustrating an example of a pattern image 400 including a fan shape according to an embodiment.

The pattern image 400 may include a pattern in which two fan shapes 410 whose origins are in contact with each other are repeated. When the pattern image 400 includes a pattern in which two fan shapes 410 whose origins are in contact with each other are repeated, the sensing apparatus 100 may determine an origin 413 in which the two fan shapes are in contact with each other as a feature point.

In addition, the sensing apparatus 100 may determine a correction value by comparing the distance to the feature point 413 sensed from the sensing apparatus 100 with the distance to the feature point 413 received from the sensing apparatus 100.

The sensing apparatus 100 may determine a feature point according to a preset algorithm. For example, the sensing apparatus 100 may determine the origin 413 where two fan shapes are in contact with each other in the acquired pattern image 400 as a feature point. Since the intensity of reflected light is weaker in the second color region than in the first color region, the sensing apparatus 100 determines the shape of the fan shapes based on the difference between the reflectance of the second color region and the first color region, and determines the origin 413 where the two fan shapes are in contact with each other, thereby determining the feature point.

For example, since the sensing apparatus 100 recognizes that only the origin portion has an angle in the fan shape, the sensing apparatus 100 may determine the feature point 413 by finding a point with an angle.

As another example, the sensing apparatus 100 determines a first line segment 411 formed on a first color region and a second line segment 412 formed on a second color region, and may determine the intersection 413 of the first line segment 411 and the second line segment 412 as a feature point 413. Here, the sensing apparatus 100 may use a line segment longer than a preset value as the second line segment 412 formed on the second color region.

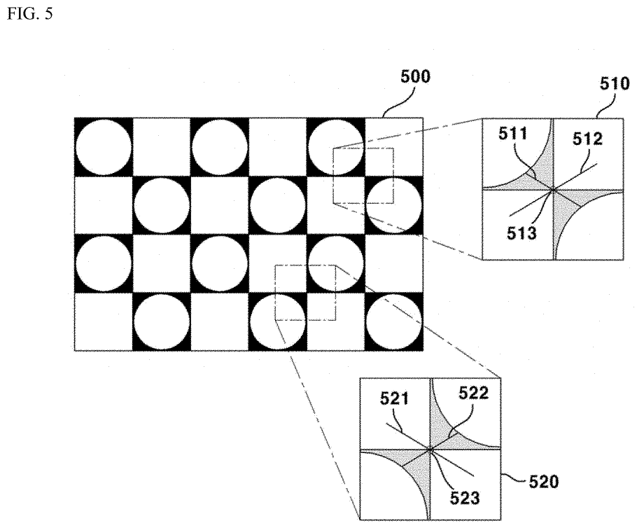

FIG. 5 is a diagram illustrating an example of a pattern image 500 including a plurality of closed curve shapes according to an embodiment.

The pattern image 500 includes a pattern in which a first single closed curve (e.g., a square) including a plurality of angles and a second single closed curve (e.g., a circle) in the shape of a curve and included in the first single closed curve are repeated.

A single closed curve according to an embodiment refers to a closed figure with the same start point and end point when a point is picked on a straight line or curve, such as a polygon, a circle, or an ellipse, and is not necessarily composed of only a curve. The pattern image 500 may include a pattern in which a first single closed curve and a second single closed curve included inside the first single closed curve are repeated. Here, a region between the first single closed curve and the second single closed curve may be colored, and the inner region of the second single closed curve may be colorless.

The sensing apparatus 100 according to an embodiment may determine the points 513 and 523 where multiple first single closed curves are in contact with one another as the feature points 513 and 523.

In addition, the sensing apparatus 100 may determine a correction value by comparing the distance to the feature points 513 and 523 sensed from the sensing apparatus 100 and the distance to the feature points 513 and 523 received from the sensing apparatus 100.

The sensing apparatus 100 may determine the feature points 513 and 523 according to a preset algorithm. For example, the sensing apparatus 100 may determine the points 513 and 523 where multiple first single closed curves are in contact with one another as the feature points 513 and 523 in the acquired pattern image 500. Since the second color region has a weaker intensity of reflected light than the first color region, the sensing apparatus 100 determines the shape of the first single closed curve based on the difference between the reflectance of the second color region and the first color region, and determine the points 513 and 523 where the two first single closed curves are in contact with each other, thereby determining the feature points 513 and 523.

For example, since the sensing apparatus 100 does not recognize an angle in a circular shape, the sensing apparatus 100 may determine the feature points 513 and 523 by finding a point with an angle.

As another example, the sensing apparatus 100 determines first line segments 512 and 521 formed on a first color region and second line segments 511 and 522 formed on a second color region, then may determine the intersections 513 and 523 of the first line segments 512 and 521 and the second line segments 511 and 522 as feature points 513 and 523. Here, the sensing apparatus 100 may use a line segment longer than a preset value as the second line segments 511 and 522 formed on the second color region.

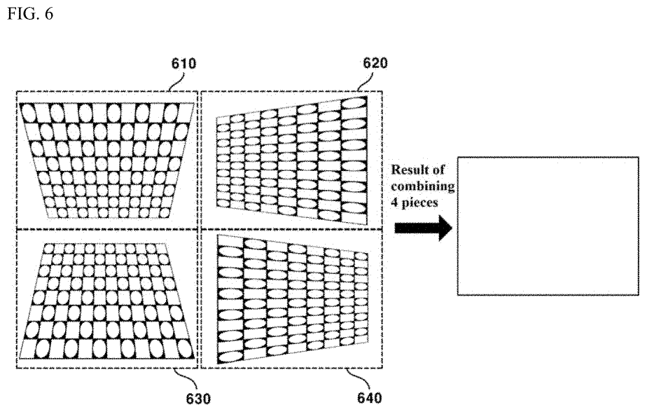

FIG. 6 is a diagram illustrating an example of acquiring a plurality of pattern images through capturing multiple times of a pattern image 500 according to an embodiment.

The sensing apparatus 100 may acquire four different pattern images 610, 620, 630, and 640 by capturing the pattern image 500 while rotating in a clockwise direction by about 90 degrees with respect to the axis directed by the sensor 120. Since the pattern image 500 is inclined at an angle of θ, the distance sensed by the same pixel in the sensor 120 may be determined differently in the four different pattern images 610, 620, 630, and 640.

The pattern image 500 includes a second color region and a first color region, and the entire area of the overlapping image 650 in which a plurality of pattern images 610, 620, 630, and 640 are overlapped is determined at least once as a first color region. The overlapping image 650 may be an image in which an area determined as the first color region of the plurality of pattern images 610, 620, 630, and 640 at least once is indicated as colorless.

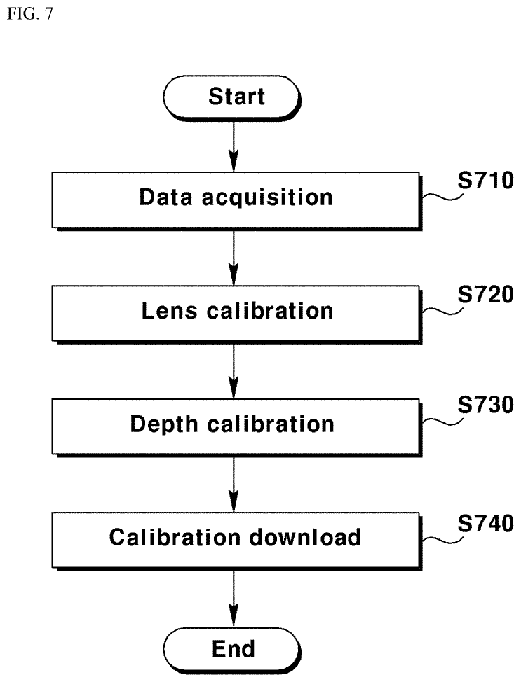

FIG. 7 is a flowchart illustrating an example in which a sensing apparatus 100 performs calibration according to an embodiment.

In step S710, the sensing apparatus 100 according to an embodiment may obtain information from a pattern image. For example, the sensing apparatus 100 may acquire a plurality of different pattern images by capturing the pattern image multiple times.

In step S720, the sensing apparatus 100 according to an embodiment may perform lens calibration. A calibration value for correction can be extracted by measuring an error that occurs when the sensor and lens are assembled. Calibration may be an example of correction.

In step S730, the sensing apparatus 100 according to an embodiment may correct a distance error for each pixel. The sensing apparatus 100 may compare the sensed distance information with the received distance information to correct an error that occurs when pixels included in the sensor sense the distance.

In step S740, the sensing apparatus 100 according to an embodiment may store a correction value in a memory.

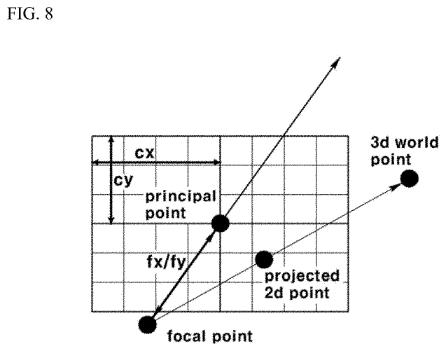

FIG. 8 illustrates an example in which a sensing apparatus 100 according to an embodiment measures an error generated when assembling a sensor and a lens, and extracts a calibration value for correction. Specifically, referring to FIG. 8, an example of correcting a focal point is illustrated.

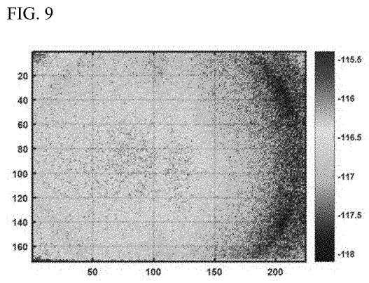

FIG. 9 illustrates an example in which a sensing apparatus 100 according to an embodiment corrects a distance error for each pixel. The sensing apparatus 100 may compare the received distance information and the sensed distance information to correct an error that occurs when pixels included in the sensor sense the distance.

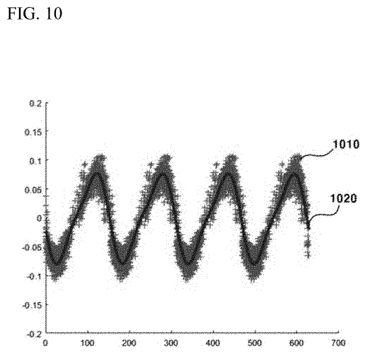

FIG. 10 illustrates an example in which a sensing apparatus 100 according to an embodiment corrects a distance error for each distance.

The first graph 1010 represents a value acquired through sensing multiple times. Specifically, the acquired value according to sensing is indicated by a + sign. Also, the second graph 1020 may represent a fitted value based on the acquired information.

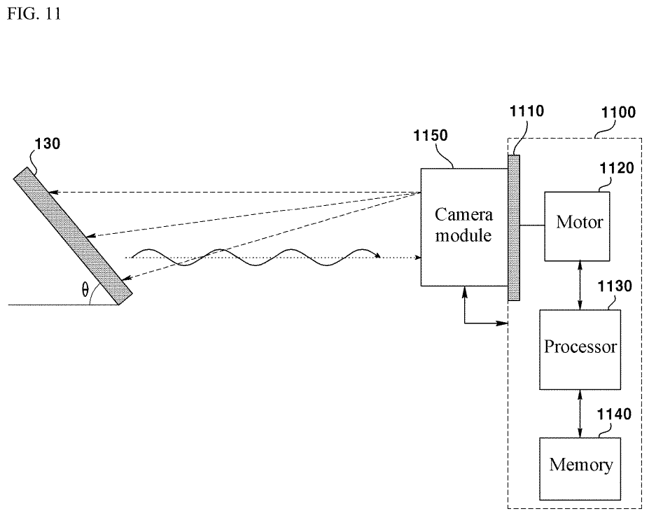

FIG. 11 is a block diagram illustrating an example in which a calibration apparatus 1100 operates in conjunction with a camera module 1150 according to an embodiment.

As illustrated in FIG. 11, the calibration apparatus 1100 may include a fixing member 1110, a motor 1120, a processor 1130, and a memory 1140.

However, it can be understood by a person skilled in the art that other general purpose components other than the components illustrated in FIG. 11 may be further included in the calibration apparatus 1100. For example, the calibration apparatus 1100 may further include a pattern image 130. Or, according to another embodiment, it may be understood by a person skilled in the art that some of the components illustrated in FIG. 11 may be omitted. For example, the fixing member 1110 may be omitted from the calibration apparatus 1100.

The memory 1140 according to an embodiment may store distance information on a feature point indicated by a repetitive shape included in the pattern image.

The camera module 1150 according to an embodiment may acquire a plurality of pattern images by capturing the pattern images 130 at different angles. The calibration apparatus 1100 may receive distance information sensed for feature points included in a plurality of pattern images from the camera module 1150. The processor 1130 included in the calibration apparatus 1100 may determine a correction value by comparing distance information stored in the memory 1140 with sensed distance information received from the camera module 1150. The processor 1130 may determine a correction value for correcting a difference between the ideal distance value stored in the memory 1140 and the distance value according to the actually sensed distance information.

The motor 1120 according to an embodiment may rotate the camera module 1150 under control of the processor 1130. For example, the motor 1120 rotates the camera module 1150 fixed through the fixing member 1110 at intervals of 90 degrees according to the control of the processor 1130, so that the camera module 1150 becomes the pattern image 130 It is possible to obtain a plurality of pattern images by capturing multiple times at different angles.

Meanwhile, the above-described method can be written as a program that can be executed on a computer, and can be implemented in a general purpose digital computer that operates the program using a computer readable recording medium. In addition, the structure of data used in the above-described method can be recorded on a computer readable recording medium through various means. The computer-readable recording medium includes storage media such as magnetic storage media (e.g., ROM, RAM, USB, floppy disk, hard disk, etc.), optical reading media (e.g., CD-ROM, DVD, etc.).

Those of ordinary skill in the technical field related to the present embodiment will appreciate that it may be implemented in a modified form without departing from the essential characteristics of the above-described description. Therefore, the disclosed methods should be considered from an explanatory point of view rather than a limiting point of view. The scope of the present invention is presented in the claims rather than the above description, and all differences within the scope equivalent thereto should be construed as being included in the present invention.

1-10. (canceled)

11. A sensing apparatus comprising:
a receiver for receiving distance information on a feature point indicated by a repetitive shape included in a pattern image;
a sensor for acquiring a plurality of pattern images through capturing multiple times of the pattern image from different angles, determining the feature point from the plurality of pattern images, and sensing distance information on the feature point; and
a processor for comparing the received distance information with the sensed distance information, and determining a correction value being used when sensing the distance information.

12. The sensing apparatus according to claim 11, wherein the pattern image includes a second color region and a first color region, a reflectance of the first color region is greater than that of the second color region, and the entire area of an overlapping image in which the plurality of pattern images are overlapped is determined at least once as the first color region.

13. The sensing apparatus according to claim 11, wherein the pattern image includes a pattern in which two fan shapes whose origin are in contact with each other are repeated.

14. The sensing apparatus according to claim 13, wherein the origin where the two fan shapes are in contact with each other is determined as the feature point.

15. The sensing apparatus according to claim 11, wherein the pattern image includes a pattern in which dots are repeatedly disposed at preset intervals.

16. The sensing apparatus according to claim 15, wherein a center point of each dot is determined as the feature point.

17. The sensing apparatus according to claim 11, wherein the pattern image includes a pattern in which a first single closed curve including a plurality of angles and a second single closed curve that is in the shape of a curve and is contained within the first single closed curve are repeated.

18. The sensing apparatus according to claim 17, wherein a region between the first single closed curve and the second single closed curve is colored and a region inside the second single closed curve is colorless.

19. The sensing apparatus according to claim 17, wherein the point where a plurality of first single closed curves are in contact with each other is determined as a feature point

20. A sensing method comprising the steps of:
receiving distance information on a feature point indicated by a repetitive shape included in a pattern image;
acquiring a plurality of pattern images through capturing the pattern image multiple times from different angles;
determining the feature point from the plurality of pattern images, and sensing distance information on the feature point; and
comparing the received distance information with the sensed distance information, and determining a correction value being used when sensing the distance information.

21. The sensing method according to claim 20, wherein the pattern image includes a second color region and a first color region, a reflectance of the first color region is greater than that of the second color region, and the entire area of an overlapping image in which the plurality of pattern images are overlapped is determined at least once as a first color region.

22. The sensing method according to claim 20, wherein the pattern image includes a pattern in which two fan shapes whose origin are in contact with each other are repeated.

23. The sensing method according to claim 22, wherein the origin where the two fan shapes are in contact with each other is determined as the feature point.

24. The sensing method according to claim 20, wherein the pattern image includes a pattern in which dots are repeatedly disposed at preset intervals.

25. The sensing method according to claim 24, wherein a center point of each dot is determined as the feature point.

26. The sensing method according to claim 20, wherein the pattern image includes a pattern in which a first single closed curve including a plurality of angles and a second single closed curve that is in the shape of a curve and is contained within the first single closed curve are repeated.

27. The sensing method according to claim 26, wherein a region between the first single closed curve and the second single closed curve is colored and a region inside the second single closed curve is colorless.

28. The sensing apparatus according to claim 26, wherein the point where a plurality of first single closed curves are in contact with each other is determined as a feature point

29. A calibration apparatus comprising:
a memory for storing distance information on a feature point indicated by a repetitive shape included in a pattern image; and
a processor for receiving a sensed distance information for feature points included in a plurality of pattern images acquired by capturing the pattern image from different angles, and determining a correction value by comparing the stored distance information with the sensed distance information,
wherein the pattern image includes a first color region and a second color region, a reflectance of the first color region is greater than that of the second color region, and the entire area of the overlapping image in which the plurality of pattern images are overlapped may be determined at least once as a first color region.

30. The calibration apparatus according to claim 29, wherein a motor for rotating the camera module for capturing the pattern image may be further included.
